(19) United States
(12) Patent Application Publication
(10) Pub. No.: US 2007/0089331 A1
(43) Pub. Date: Apr. 26, 2007

(54) Foldable Desk Pad

(75) Inventor: Abby J. Howes, Sidney Center, NY (US)

Correspondence Address: BOND, SCHOENECK & KING, PLLC, ONE LINCOLN CENTER, SYRACUSE, NY, 13202-1355, US

(73) Assignee: MEADWESTVACO CORPORATION, Glen Allen, VA (US)

(21) Appl. No.: 11/538,540

(22) Filed: Oct. 4, 2006

Related U.S. Application Data
(60) Provisional application No. 60/596,637, filed on Oct. 7, 2005.

(51) Int. Cl. G09D 3/04

(52) U.S. Cl. 40/121

(57) ABSTRACT

The present invention provides a calendar desk pad, comprising a base member having a first major surface area and extending along a longitudinal axis, a plurality of calendar pages removably associated with the base member and lying in stacked, respective planes that overlie the first major surface area, and a fold line that extends transverse to the longitudinal axis and about which the base member and the plurality of calendar pages are adapted to collectively fold.

### CLAIM OF PRIORITY

The present application claims priority to U.S. Provisional Application Ser. No. 60/596,637, filed Oct. 7, 2005, the entire disclosure of which is hereby incorporated by reference.

### BACKGROUND OF THE INVENTION

1. Field of Invention

The present invention relates generally to desk pads, and more particularly to calendar desk pads.

2. Description of Prior Art

Desk pads are traditionally used to provide a protective buffer between a desk top and the user of the desk. Most often, desk pads provide a flat writing surface that is large enough to cover a substantial work area for its user, and a material composition that will provide protection to the desk top. To enhance the functionality of the desk pad, monthly calendars may form the working surface of the desk pad, with each month being separable from the desk pad so that the current month can always be displayed to the user.

A drawback of the calendar type desk pad is that due to its large size, the owner of the desk pad must maintain a portable calendar (e.g., a wire bound organizer/planner) that duplicates the information written on the desk pad calendar if that person needs to know his or her schedule when not located at his or her desk. From a merchandising perspective, the traditional desk pads also require a large amount of space to be displayed to a potential customer.

3. Objects and Advantages

It is therefore a principal object and advantage of the present invention to provide a calendar type desk pad that is convertible between a full desk pad size and a portable size.

It is another object and advantage of the present invention to provide a desk pad that may be displayed at the point of sale in an area that is smaller than the size of the full desk pad.

Other objects and advantage of the present invention will in part be obvious, and in part appear hereinafter.

### SUMMARY OF THE INVENTION

In accordance with the foregoing objects and advantages, the present invention provides a calendar desk pad, comprising a base member having a first major surface area and extending along a longitudinal axis, a plurality of calendar pages removably associated with the base member and lying in stacked, respective planes that overlie the first major surface area, and a fold line that extends transverse to the longitudinal axis and about which the base member and the plurality of calendar pages are adapted to collectively fold. In a preferred embodiment, the fold line bisects the pad into two equal halves. To maintain the calendar pages and base member in association with one another, a pair of pliable bands encircling opposing edges of the collective pages is provided. Each calendar page may simply be separated from the remaining pages and the support member, however, by pulling its side edges out from behind the bands, thereby removing the gathering force that maintains the association.

### BRIEF DESCRIPTION OF THE DRAWINGS

The present invention will be more fully understood and appreciate by reading the following Detailed Description in conjunction with the accompanying drawings, in which:

FIG. 1 is a top plan view of the present invention;

FIG. 2 is a top plan view of the present invention with portions of the calendar pages turned back;

FIG. 3 is a top plan view of the present invention shown in its folded position; and

FIG. 4 is an end elevation view taken long view line 4-4 of FIG. 2.

### DETAILED DESCRIPTION

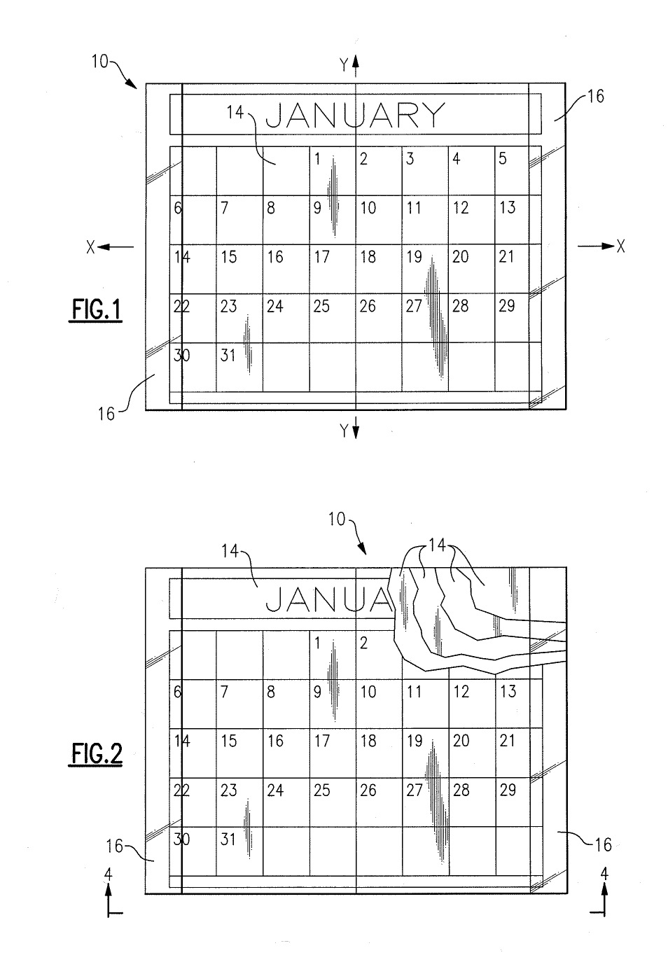

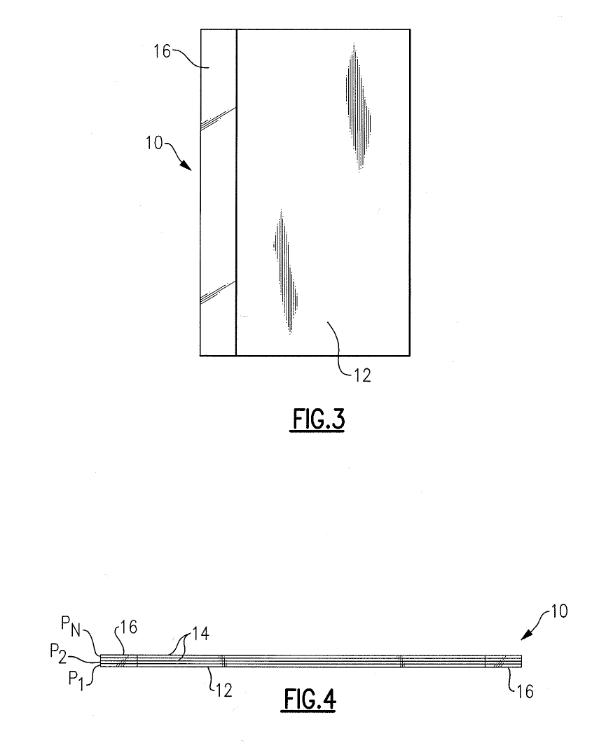

Referring now to the drawings, in which like reference numerals refer to like parts throughout, there is seen in FIGS. 1, 2 and 4, a desk pad, designated generally by reference numeral 10, essentially comprising a base member 12 and a plurality of individual calendar pages 14. Base member 12 and calendar pages 14 each lie is respective, parallel planes P1-Pn (see FIG. 4), with each calendar page 14 overlying the major surface of base member 12. In its preferred form, calendar pages 14 provide monthly calendar pages, such that one complete month worth of calendar is visible on the uppermost page at any give time. Other time allotments are, of course, within the scope of the present invention.

Desk pad 10 is preferably, though not necessarily, rectangular in plan form, and extends along a longitudinal axis X-X. Pages 14 are preferably composed of paper, and base member 12 is preferably composed of a material that is slightly more rigid/durable than paper, such as paperboard. Each of the pages 14 and base member 12 are scored along a common axis Y-Y that is transverse to longitudinal axis X-X, such that desk pad 10 (i.e., pages 14 and base member 12 collectively) is foldable about axis Y-Y. In the preferred embodiment, axis Y-Y bisects pages 14 and base member 12, such that they are divided into two equal halves. By folding desk pad 10 in half, not only does it become easier to handle for the end user who may desire to take the calendar off his or her desk and move it to another location, but it also makes it easier for stores to merchandise and display at its point of sale. For instance, a point of sale rack holding and displaying desk pads 10 need only be half as wide as a rack that displays traditional desk pads (i.e., desk pads that are not foldable), thereby saving valuable store display space.

To maintain calendar pages 14 in associated relation to one another and to base member 12, a pair of flexible bands 16 encircling opposed edges of desk pad 10 are provided. Calendar pages 14 and base member 12 are all encompassed by bands 16, but are otherwise disconnected from one another. Thus, in order to separate one calendar page 14 from desk pad 10, that page can simply be pulled out from beneath bands 16.

The present invention has been described in reference to its preferred mode. It should be understood that changes may be made to the invention described herein without departing from the full scope and spirit of the present invention as defined by the appended claims.

What is claimed is:

1. A desk pad, comprising:
a. a base member having a first major surface area and extending along a longitudinal axis;
b. a plurality of calendar pages removably associated with said base member and lying in stacked, respective planes that overlie said first major surface and are parallel to said first plane;
c. said base member and said plurality of calendar pages each having a respective fold line that extend along a common axis that is transverse to said longitudinal axis and about which sad base member and said plurality of calendar pages are adapted to collectively fold.

2. The desk pad according to claim 1, wherein said fold line bisects said base member and said plurality of calendar pages in equal halves.

3. The desk pad according to claim 1, wherein said base member includes first and second opposing side edges and further comprises first and second bands associated with said first and second edges, respectively, and adapted to releasably retain said plurality of calendar pages relative to said base member.

4. The desk pad according to claim 3, wherein said first and second bands encircle said first and second edges, respectively.

5. The desk pad according to claim 1, wherein said plurality of calendar pages are each loosely positioned relative to said base member.

6. The desk pad according to claim 1, wherein said base member is composed of a semi-rigid material.

7. The desk pad according to claim 6, wherein said semi-rigid material is paperboard.

8. The desk pad according to claim 1, wherein said plurality of calendar pages are each composed of paper.
